(19) United States
(12) Patent Application Publication
(10) Pub. No.: US 2005/0018981 A1
(43) Pub. Date: Jan. 27, 2005

(54) Receiver optical sub-assembly with reduced back reflection

(75) Inventors: Robert Modavis, Painted Post, NY (US); Timothy Douglas Goodman, Windsor, CA (US); Roger T. Lindquist, Dodge Centre, MN (US); Chris Hart, West Melbourne, FL (US); William K. Hogan, Rochester, MN (US)

Correspondence Address: Allen, Dyer, Doppelt, Milbrath & Gilchrist, P.A.;1401 Citrus Center, 255 South Orange Avenue, Box 3791, Orlando, FL, 32802-3791, US

(73) Assignee: JDS Uniphase Corporation, San Jose, CA (US)

(21) Appl. No.: 10/892,843

(22) Filed: Jul. 16, 2004

Related U.S. Application Data
(60) Provisional application No. 60/489,440, filed on Jul. 23, 2003.

(51) Int. Cl. G02B 6/36

(52) U.S. Cl. 385/93; 385/92

(57) ABSTRACT

The invention relates to a receiver optical sub-assembly (ROSA) for use in an optical transceiver to convert optical signals transmitted along an optical fiber into electrical signals for use by a host device. Conventionally, light exiting the optical fiber inside an optical coupler of the ROSA encounters a refractive index mismatched interface, e.g. fiber/air, causing a portion of the light to be reflected directly back into the fiber. To minimize back reflections at the interface with the optical fiber, an optical insert is provided having an index of refraction matching that of the optical fiber, thereby moving the mismatched interface remote from the end of the fiber to an interface of the optical insert and a lens, to which the optical insert is attached.

### CROSS-REFERENCE TO RELATED APPLICATIONS

The present invention claims priority from U.S. Patent Application No. 60/489,440 filed Jul. 23, 2003, which is incorporated herein by reference.

### TECHNICAL FIELD

The present invention relates to a receiver optical sub-assembly (ROSA), and in particular to a ROSA with reduced back reflection.

### BACKGROUND OF THE INVENTION

Back reflection is a source of optical noise and the reduction of the level of back reflection is necessary for optimizing performance of the ROSA. Moreover, some communications standards, e.g. SONET, require that the receiver optical back reflection be less than specified limits, e.g. −27 dB.

In a conventional ROSA 1, illustrated in FIG. 1, a photo-detector 2 is mounted on a substrate 3, along with other electronic circuitry, such as a trans-impedance amplifier 4. Electrical leads 6 extend outwardly from the rear of the ROSA 1 for electrically connecting the electronic circuitry to a transceiver circuit board (not shown). The substrate 3 is mounted in a container, such as a transistor outline (TO) can 7, which in turn is mounted in a housing 8. The housing 8 also encloses a ball lens 9, used to focus an optical signal from an optical fiber (not shown) onto the photo-detector 2. An optical connector 11 is connected to the housing 8 using a mounting collar 12. The optical connector positions an end of the optical fiber proximate the lens 9. To reduce back reflection, a fiber stub 15 is provided inside the optical connector 11 for mating with the optical fiber. The fiber stub has and angled output end for tilting the beam so that reflections from the photo-detector 2 are not coupled back into the optical fiber. Unfortunately, the conventional structure of FIG. 1 includes several small requiring a complicated assembly process. Moreover, the cores of the optical fiber and the fiber stub 15 must be accurately aligned or large coupling losses result.

An alternative to the ROSA assembly of FIG. 1 is disclosed in U.S. Pat. No. 6,302,596 issued Oct. 16, 2001 in the name of Cohen et al, and illustrated in FIG. 2. A fiber connector 21, a housing 28 and a lens 29 are all integrally molded into a single unit, generally indicated at 30. An optical signal exits the end of the optical fiber and passes through air in a recess 32 to the lens 29, which focuses the optical signal onto a photo-detector at normal incidence. The recess 32 is provided as a “dust collector” to prevent dirt or other foreign materials from contaminating and being imbedded into the plastic interface surface 33. This ROSA design greatly simplifies the assembly process; however, the problem of back reflection still exists. The main sources of back reflection occur at the perpendicular optical fiber-to-air interface and from the surface of the photo-detector. Since the optical fiber input must have a perpendicular end face, there is a need to suppress the ˜4% back reflection.

An object of the present invention is to overcome the shortcomings of the prior art by providing a relatively simple ROSA assembly with limit back reflection.

### SUMMARY OF THE INVENTION

Accordingly, the present invention relates to a receiver optical sub-assembly device for converting an optical signal into an electrical signal comprising:
an optical coupler for holding an end of an optical fiber, which transmits the optical signal;
a photo-detector for converting the optical signal into an electrical signal;
a lens disposed between the optical coupler and the photo-detector for focusing the optical signal onto the photo-detector;
an electrical connector electrically connected to the photo-detector for transmitting the electrical signal to a host device; and
an optical insert coupled to the lens inside the optical coupler for contacting an end of the optical fiber when disposed therein, the optical insert having an index of refraction substantially the same as the optical fiber, whereby substantially no light is reflected at an interface of the optical insert and the optical fiber, and whereby any light reflected off an interface of the optical insert and the lens will have expanded by such an amount to greatly reduce any light coupling back into the optical fiber.

### BRIEF DESCRIPTION OF THE DRAWINGS

The invention will be described in greater detail with reference to the accompanying drawings which represent preferred embodiments thereof, wherein:

FIG. 1 illustrates a side view of a conventional ROSA;

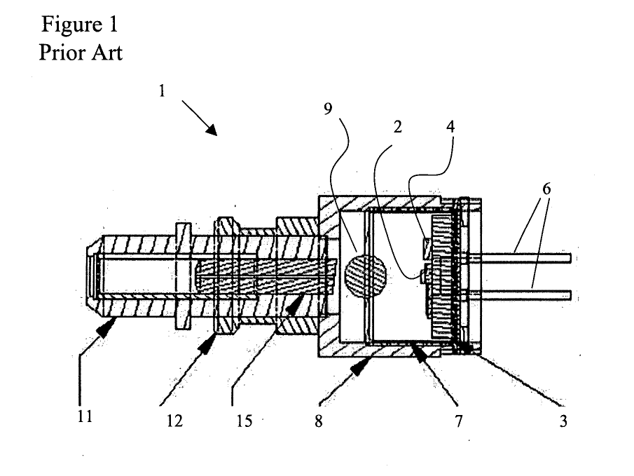

FIG. 2 illustrates a side view of a conventional one piece ROSA;

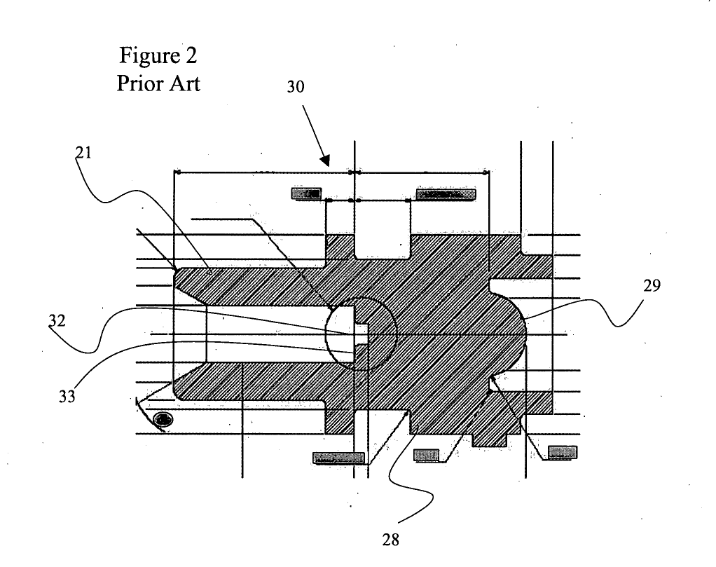

FIG. 3 illustrates a side view of a ROSA according to the present invention;

FIG. 4 illustrates a side view of another embodiment of a ROSA according to the present invention; and

FIG. 5 illustrates a side view of another embodiment of a ROSA according to the present invention.

### DETAILED DESCRIPTION

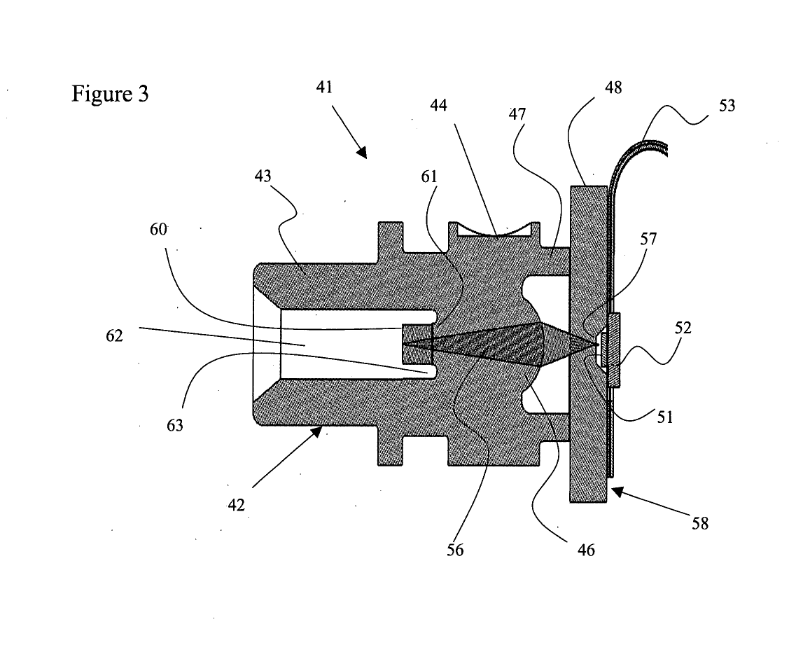

With reference to FIG. 3, the ROSA assembly, generally indicated at 41, according to the present invention includes a molded plastic one-piece front-end unit 42 defining an optical connector 43, a housing 44, a focusing lens 46, and a mounting collar 47. The front-end unit 42 is constructed from an optical grade plastic, e.g. ULTEM1010. A substrate 48 is fixed to the mounting collar 47 for supporting a photo-detector 51 and other electronic devices, i.e. trans-impedance amplifier 52. Electrical leads, preferably in the form of flexible electrical cable 53, transmit electrical information to and from the photo-detector 51 and the other electronic devices, e.g. trans-impedance amplifier 52. The substrate 48 provides a stiffener for the flexible electrical cable 53. In a preferred embodiment, the substrate 48 is transparent to optical signal 56, thereby enabling the optical signal 56 to pass therethrough to the photo-detector 51. The photo-detector 51 is flip-chip mounted to the trans-impedance amplifier 52, which is mounted to the substrate 48. A recess 57 is provided in the rear surface 58 of the substrate 48 for receiving the photo-detector 51 suspended therein, whereby an outer edge of a front face of the trans-impedance amplifier 52 is attached to a shoulder formed on the rear surface 58 around the recess 57. Alternatively, the recess 57 could extend all the way through the substrate 48, enabling the optical signal 56 to pass unobstructed to the photo-detector 51.

To limit back reflections as the optical signal 56 exits the optical fiber, an index-matching optical insert 60 is mounted on a front surface 61 of the focusing lens 46. The optical insert 60 has an index of refraction closely matching that of the optical fiber. Preferably, the optical insert 60 is a rectangular or cylindrical block of silica, BK7, or Borosilicate float glass. Ideally the optical insert 60 is fixed to the front surface 61 using an index-matching adhesive, preferably having an index of refraction midway between the index of refraction of the optical insert 60 and the index of refraction of the plastic front end unit 42. Alternatively, the optical insert 60 can be mounted to the front surface 61 by some other means, such as press fitting.

Ideally the optical insert 60 projects outwardly into the cavity 62 of the optical connector 43 forming a trough 63 therearound. The trough 62 will provide an area for collecting any dust or foreign particles entering the cavity 62 to prevent this material from being embedded into the optical insert 60.

Since the optical fiber is silica based, the reflection at the optical fiber/optical insert 60 interface is negligible. The difference in refractive index at the optical insert 60/plastic lens 46 interface does result in a small amount of back reflection. However, as is illustrated in FIG. 3, the optical signal 56 expands prior to hitting the front surface 61, and continues to expand as it is reflected back to the optical fiber. Accordingly, the overlap between the back reflected light and the optical fiber mode is relatively small, i.e. only a small fraction of the optical signal 56 is reflected back to the optical fiber. To reduce the back reflection even further, the size of the optical insert 60 can be increased beyond the usual 0.8 mm length.

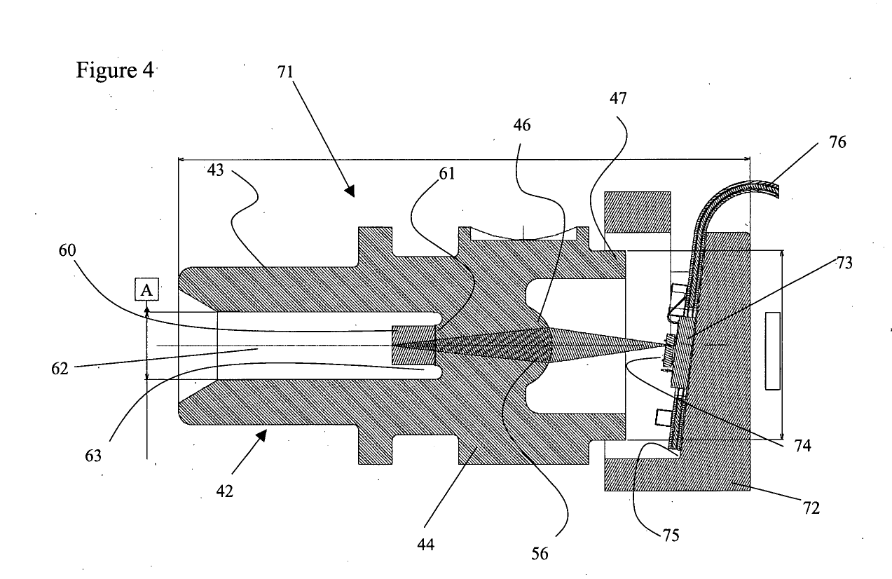

In another embodiment of the present invention illustrated in FIG. 4, the ROSA assembly, generally indicated at 71 includes the same one-piece molded front-end unit 42, defining the optical coupler 43, the housing 44, the focusing lens 46, and the mounting collar 47. Similarly, the optical insert 60 is fixed to the front surface 61 in the cavity 62 defining the trough 63 therearound. A flex ring substrate 72 is connected to the mounting collar 47, and supports a rear face of a trans-impedance amplifier 73 on a mounting face 75 thereof. A photo-detector 74 is flip-chip mounted onto the trans-impedance amplifier 73, and a flexible electrical cable 76 electrically connects the trans-impedance amplifier 73, inter alia, to a transceiver circuit board (not shown). In this case the flex-ring substrate 72 can be constructed out of a material with high thermal conductivity, i.e. >100 W/m° K, e.g. zinc, aluminum, which enables the ROSA 71 to run at higher operating temperatures before thermally induced noise becomes a factor. To further reduce back reflections, the photo-detector 74 is mounted at a non-normal angle to the incoming optical signal 56, so that any reflected light will not be reflected directly back through the lens 46. The mounting face 75 is at a nominal angle of between −4 and −10°, preferably −7°, from a plane normal to the incoming optical signal 56. The flex-ring substrate 72 includes a mounting ring 72a for attachment to the mounting collar 47.

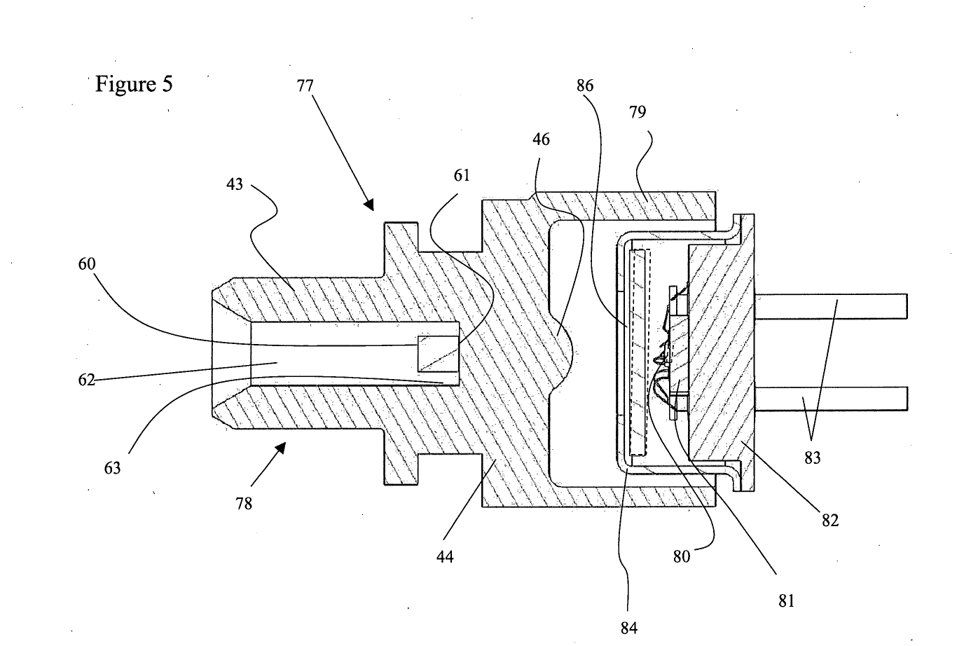

In another embodiment of the present invention illustrated in FIG. 5, the ROSA assembly, generally indicated at 77 includes a similar one-piece molded front-end unit 78, defining the optical coupler 43, the housing 44, and a focusing lens 46. The mounting collar 47 is replaced by a slightly larger mounting sleeve 79. Similarly, the optical insert 60 is fixed to the front surface 61 in the cavity 62 by the index-matching adhesive defined above defining the trough 63 therearound. A photo-detector 80 is mounted on a trans-impedance amplifier 81, which is mounted on a substrate 82. Electrical leads 83 extend from the rear of the ROSA 77 for electrically connecting the electronic circuitry to a transceiver circuit board (not shown). The substrate 82 is mounted in a container, such as a transistor outline (TO) can 84, which in turn is mounted in the mounting sleeve 79 of the housing 44. Preferably, a flat or tilted (−4° to −10°) transparent, e.g. glass, window 86, as shown in outline, with an Anti-Reflective coating is provided to hermetically seal the TO can 84. The photo-detector 80 could also be mounted at a slight angle, as shown in outline, to further reduce back reflections.

1. A receiver optical sub-assembly device for converting an optical signal into an electrical signal comprising:
an optical coupler for holding an end of an optical fiber, which transmits the optical signal;
a photo-detector for converting the optical signal into an electrical signal;
a lens disposed between the optical coupler and the photo-detector for focusing the optical signal onto the photo-detector;
an electrical connector electrically connected to the photo-detector for transmitting the electrical signal to a host device; and
an optical insert coupled to the lens inside the optical coupler for contacting an end of the optical fiber when disposed therein, the optical insert having an index of refraction substantially the same as the optical fiber, whereby substantially no light is reflected at an interface of the optical insert and the optical fiber, and whereby any light reflected off an interface of the optical insert and the lens will have expanded by such an amount to greatly reduce any light coupling back into the optical fiber.

2. The device according to claim 1, wherein the lens and the optical coupler are integrally formed from a same plastic material defining a single front-end unit.

3. The device according to claim 2, further comprising a substrate for supporting the photo-detector;
wherein the front-end unit includes a mounting collar for connecting to the substrate.

4. The device according to claim 3, further comprising a trans-impedance amplifier flip-chip coupled to the photo-detector, whereby the trans-impedance amplifier is mounted on the substrate.

5. The device according to claim 4, wherein the substrate includes a recess in a first surface for receiving the photo-detector;
wherein an edge of the trans-impedance amplifier is connected to the first surface, whereby the photo-detector is suspended in the recess.

6. The device according to claim 5, wherein the substrate is transparent to the optical signal, whereby a second surface of the substrate opposite the first surface is connected to the mounting collar.

7. The device according to claim 3, wherein the photo-detector is mounted at a non-normal angle to the incoming optical signal, whereby any light reflected off the photo-detector will not couple directly back into the optical fiber.

8. The device according to claim 7, wherein a first surface of the substrate supports the photo-detector;
wherein the first surface of the substrate is disposed at an angle of 4° to 10° from a plane normal to the direction of the optical signal.

9. The device according to claim 8, wherein the substrate includes a mounted ring extending around the photo-detector for connecting to the mounting collar.

10. The device according to claim 8, wherein the substrate comprises a material with a thermal conductivity greater than 100 W/m° K.

11. The device according to claim 1, wherein the photo-detector is mounted at a non-normal angle to the incoming optical signal, whereby any light reflected off the photo-detector will not couple directly back into the optical fiber.

12. The device according to claim 11, further comprising a substrate, a first surface of which is for supporting the photo-detector;
wherein the first surface of the substrate is disposed at an angle of 4° to 10° from a plane normal to the direction of the optical signal.

13. The device according to claim 12, wherein the front-end unit includes a mounting collar; wherein the substrate includes a mounted ring for connecting to the mounting collar.

14. The device according to claim 12, wherein the substrate comprises a material with a thermal conductivity greater than 100 W/m° K.

15. The device according to claim 2, further comprising: a mounting sleeve extending from the front end unit integrally formed therewith; and a container mounted in the mounting sleeve for hermetically sealing the photo-detector therein; wherein the container includes a window transparent to the optical signal disposed at a non-normal angle to the incoming optical signal for preventing light from being reflected directly back into the lens.

16. The device according to claim 1, wherein the optical insert is comprised of a material selected from the group consisting of silica, BK7, and borosilicate float glass.

17. The device according to claim 1, further comprising an adhesive for connecting the optical insert to the lens, wherein the adhesive has an index of refraction between the index of refraction of the optical insert and the index of refraction of the lens.

18. The device according to claim 1, wherein the optical insert extends into the optical coupler forming a trough therearound for collecting debris entering into the optical coupler.
